(19) United States
(12) Patent Application Publication
(10) Pub. No.: US 2026/0211805 A1
(43) Pub. Date: Jul. 23, 2026

(54) STORAGE DEVICE CAPABLE OF AUTOMATICALLY DELETING DATA AND A METHOD OF OPERATION THEREOF

(71) Applicant: SK hynix Inc., Icheon-si (KR)

(72) Inventor: Jang Hun YUN, Icheon (KR)

(21) Appl. No.: 19/222,687

(22) Filed: May 29, 2025

(30) Foreign Application Priority Data
Jan. 23, 2025 (KR) 10-2025-0009927

(51) Int. Cl. G06F 12/02

(52) U.S. Cl. CPC G06F 12/0223; G06F 2212/1044

(57) ABSTRACT

A storage device may comprise a memory comprising a first memory area and a controller, and may receive, from a host, a write command requesting to write first data and write the first data to the first memory area in response to the write command. Subsequently, when a predetermined deletion condition is met, the storage device may delete all or part of the data stored in the first memory area without a deletion request from the host.

### CROSS-REFERENCES TO RELATED APPLICATION

The present application claims priority under 35 U.S.C. 119(a) to Korean patent application number 10-2025-0009927 filed on January 23, 2025, which is incorporated herein by reference in its entirety.

### BACKGROUND

### 1. Technical Field

Embodiments of the present disclosure relate to a storage device capable of automatically deleting data without a deletion request from a host and a method of operation thereof.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

The frequency of use of data stored in a storage device may vary and may be difficult to predict. For example, most of the data stored in the storage device may remain completely unaccessed by the user for a period of time.

### SUMMARY

Embodiments of the present disclosure may provide a storage device capable of efficiently managing storage capacity based on the frequency of data usage, and a method of operation thereof.

Objects of embodiments of the disclosure are not limited to those set forth herein, and other unmentioned objects will be apparent to one of ordinary skill in the art from the following description.

Embodiments of the present disclosure may provide a storage device comprising: a memory comprising a first memory area; and a controller configured to receive a write command requesting to write first data from a host, write the first data to the first memory area in response to the write command. In this case, the controller may delete all or part of the data stored in the first memory area without a deletion request from the host when predetermined deletion conditions are met.

Embodiments of the present disclosure may provide a method of operating a storage device, comprising: receiving a write command requesting to write first data from a host; writing the first data to a first memory area in response to the write command; and deleting the first data from the storage device without a deletion request from the host when predetermined deletion conditions are met.

According to embodiments of the present disclosure, a storage device capable of efficiently managing storage capacity based on the frequency of data usage and a method of operation thereof may be provided.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a schematic configuration diagram of a storage device according to an embodiment of the present disclosure.

FIG. 2 is a block diagram schematically illustrating a memory of FIG. 1.

FIG. 3 is a schematic configuration diagram of a storage device according to an embodiment of the present disclosure.

FIG. 4 is a flowchart illustrating operation of the storage device according to an embodiment of the present disclosure.

FIG. 5 is a flowchart illustrating an example of an operation in which the storage device according to an embodiment of the present disclosure determines whether a deletion condition is met.

FIG. 6 illustrates an example of an operation in which the storage device according to an embodiment of the present disclosure determines second data to be deleted from a first memory area.

FIG. 7 illustrates another example of an operation in which the storage device according to an embodiment of the present disclosure determines second data to be deleted from a first memory area.

FIG. 8 illustrates an operation in which the storage device according to an embodiment of the present disclosure responds to a read command for second data deleted from a first memory area.

FIG. 9 is a flowchart illustrating an example of an operation in which the storage device according to an embodiment of the present disclosure migrates third data stored in a first memory area to a second memory area.

FIG. 10 illustrates an operation in which the storage device according to an embodiment of the present disclosure responds to the host indicating that third data has been migrated to a second memory area.

FIG. 11 is a flowchart illustrating an operation of the storage device according to an embodiment of the present disclosure.

### DETAIL DESCRIPTION

Hereinafter, embodiments of the disclosure are described in detail with reference to the accompanying drawings. In assigning reference numerals to components of each drawing, the same components may be assigned the same numerals even when they are shown on different drawings. When determined to make the subject matter of the disclosure unclear, the detailed of the known art or functions may be skipped. As used herein, when a component “includes,” “has,” or “is composed of” another component, the component may add other components unless the component “only” includes, has, or is composed of” the other component. As used herein, the singular forms “a”, “an” and “the” are intended to include the plural forms as well, unless the context clearly indicates otherwise.

Such denotations as "first," "second," "A," "B," "(a)," and "(b)," may be used in describing the components of the disclosure. These denotations are provided merely to distinguish a component from another, and the essence, order, or number of the components are not limited by the denotations.

In describing the positional relationship between components, when two or more components are described as "connected", "coupled" or "linked", the two or more components may be directly "connected", "coupled" or "linked" ", or another component may intervene. Here, the other component may be included in one or more of the two or more components that are “connected”, “coupled” or “linked” to each other.

When such terms as, e.g., “after”, “next to”, “after”, and “before”, are used to describe the temporal flow relationship related to components, operation methods, and fabricating methods, it may include a non-continuous relationship unless the term “immediately” or “directly” is used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the disclosure are described in detail with reference to the accompanying drawings.

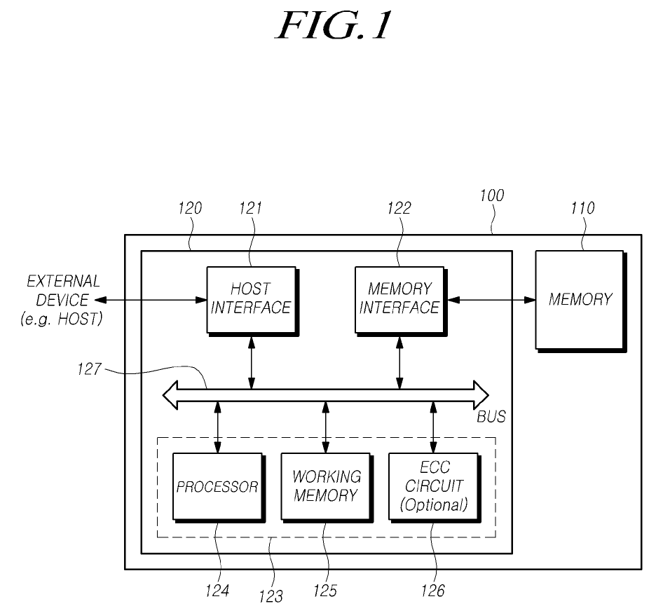

FIG. 1 is a schematic configuration diagram of a storage device 100 according to an embodiment of the disclosure.

Referring to FIG. 1, the storage device 100 may include a memory 110 that stores data and a controller 120 that controls the memory 110.

The memory 110 includes a plurality of memory blocks, and operates in response to the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping techniques of the flash translation layer, depending on a mapping unit. Representative address mapping techniques include a page mapping technique, a block mapping techniques and a hybrid mapping technique.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g. SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

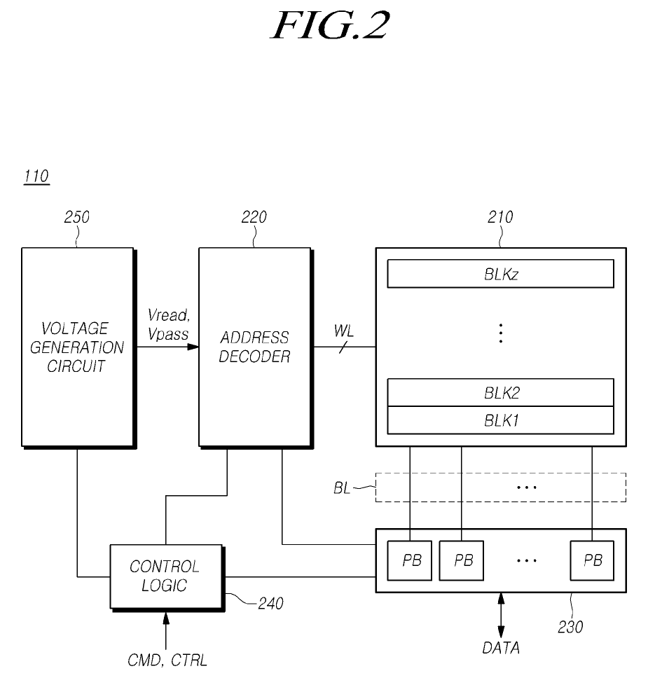

Hereinbelow, the memory 110 will be described in further detail with reference to FIG. 2.

FIG. 2 is a block diagram schematically illustrating a memory 110 of FIG. 1.

Referring to FIG. 2, the memory 110 according to an embodiment of the disclosure may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. In some implementations, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

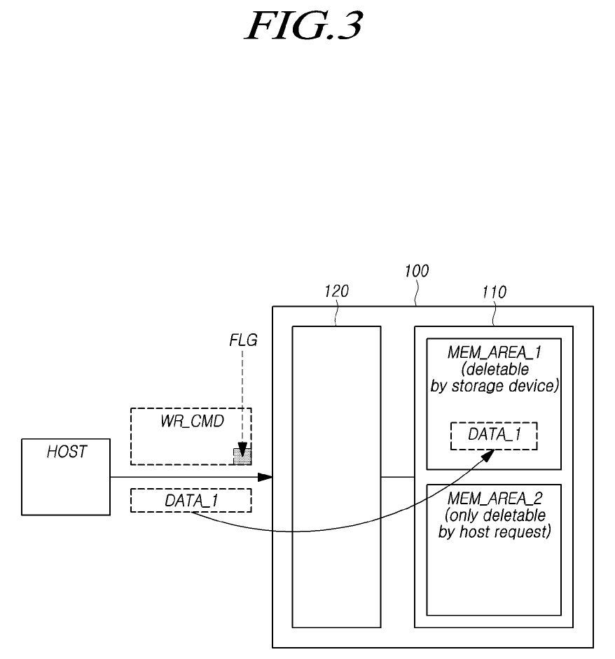

FIG. 3 is a schematic configuration diagram of the storage device 100 according to an embodiment of the present disclosure.

Referring to FIG. 3, the storage device 100 may include a memory 110 and a controller 120.

The memory 110 may include a first memory area MEM_AREA_1. In addition, the memory 110 may selectively include a second memory area MEM_AREA_2. The first memory area MEM_AREA_1 and the second memory area MEM_AREA_2 may each store data.

As an example, the memory 110 may include a plurality of memory blocks, and the first memory area MEM_AREA_1 and the second memory area MEM_AREA_2 may each include one or more of the plurality of memory blocks.

The storage capacity of the first memory area MEM_AREA_1 and the second memory area MEM_AREA_2 may be determined by a preset value or may be dynamically changed by the controller 120.

In embodiments of the present disclosure, data stored in the first memory area MEM_AREA_1 may be automatically deleted by the storage device 100. When a specific deletion condition is met, the controller 120 may automatically delete all or a portion of the data stored in the first memory area MEM_AREA_1 from the storage device 100 without a deletion request from the host HOST.

Meanwhile, the controller 120 may separately manage information on data that has been automatically deleted from the first memory area MEM_AREA_1. For example, the controller 120 may manage the logical address corresponding to data automatically deleted from the first memory area MEM_AREA_1 and information indicating that the data has been deleted. The controller 120 may store the information in the memory 110 or internally within the controller 120.

Meanwhile, the controller 120 may separately manage information on data stored in the first memory area MEM_AREA_1 that can be automatically deleted. For example, the controller 120 may separately manage information on automatically deletable data stored in the first memory area MEM_AREA_1 through a mapping table or metadata. The controller 120 may store the information in the memory 110 or internally within the controller 120.

In contrast to the data stored in the first memory area MEM_AREA_1, data stored in the second memory area MEM_AREA_2 cannot be automatically deleted by the storage device 100. Unless the controller 120 receives a deletion request from the host HOST, it must retain the data stored in the second memory area MEM_AREA_2 within the storage device 100.

The controller 120 may receive a write command WR_CMD from the host HOST.

In this case, the write command WR_CMD may request writing of first data DATA_1 and may further include a flag FLG indicating that the first data DATA_1 is deletable without a deletion request from the host HOST.

As an example, the flag FLG may be a part of a reserved field of the write command WR_CMD. The location of the flag FLG may be predefined between the host HOST and the storage device 100.

In embodiments of the present disclosure, an example has been described in which the flag FLG of the write command WR_CMD indicates that the first data DATA_1 is deletable without a deletion request from the host HOST. However, the controller 120 may also receive information, through a command other than the write command WR_CMD, indicating that the first data DATA_1 is deletable without a deletion request from the host HOST.

In response to the write command WR_CMD, the controller 120 may write the first data DATA_1 to the first memory area MEM_AREA_1. Since the first data DATA_1 is deletable from the storage device 100 without a deletion request from the host HOST, the controller 120 may store the first data DATA_1 in the first memory area MEM_AREA_1 so that it is deletable from the storage device 100 when the storage device 100 determines it is appropriate to delete the first data DATA_1.

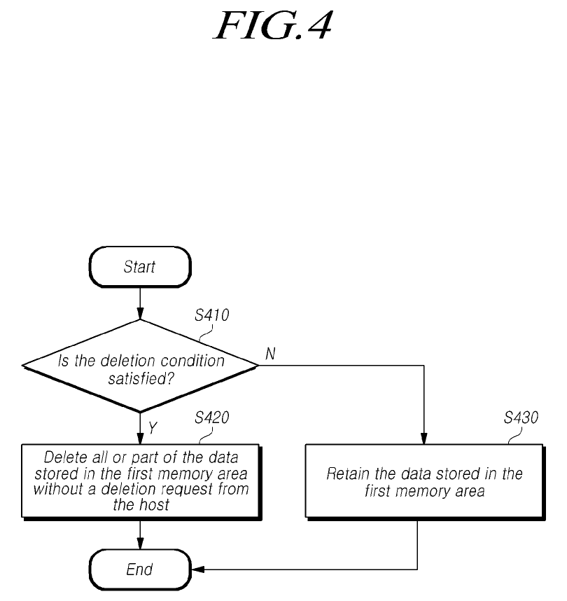

FIG. 4 is a flowchart illustrating operation of the storage device 100 according to the present disclosure.

Referring to FIG. 4, the controller 120 of the storage device 100 may determine whether a predetermined deletion condition is met (S410).

When it is determined that the deletion condition is met (S410-Y), the controller 120 may delete, without a deletion request from a host HOST, all or part of the data stored in a first memory area MEM_AREA_1 (S420). Through this process, the controller 120 may secure additional available storage capacity in the first memory area MEM_AREA_1 and, as a result, efficiently manage the storage capacity of the storage device 100.

On the other hand, when it is determined that the deletion condition is not met (S410-N), the controller 120 may maintain the data stored in the first memory area MEM_AREA_1 without deleting it (S430).

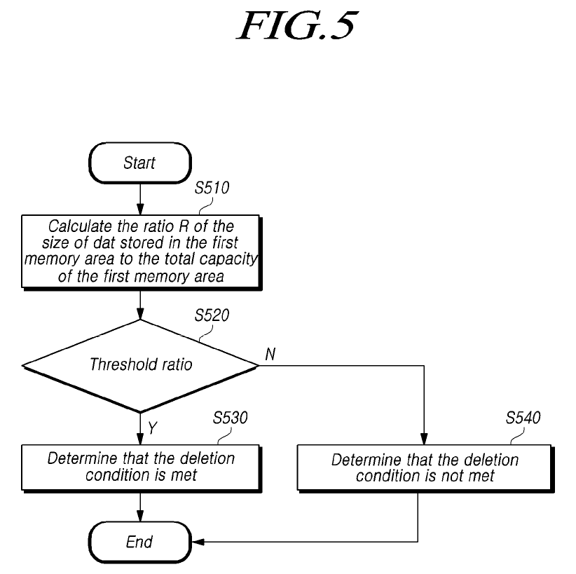

Meanwhile, the deletion condition described in S410 may be determined in various ways. An embodiment thereof will be described with reference to FIG. 5.

FIG. 5 is a flowchart illustrating an example of an operation in which the storage device 100 according to the present disclosure determines whether a deletion condition is met.

Referring to FIG. 5, the controller 120 of the storage device 100 may calculate a ratio R of the size of data stored in a first memory area MEM_AREA_1 to the total storage capacity of the first memory area MEM_AREA_1 (S510).

For example, if the total storage capacity of the first memory area MEM_AREA_1 is 1GB and the capacity of the data stored in the first memory area MEM_AREA_1 is 256MB, then R may be 0.25.

The controller 120 determines whether the ratio R calculated in operation S510 is equal to or greater than a predetermined threshold ratio (S520). In this case, the threshold ratio may be a preset ratio value or may be a ratio value (e.g., the ratio of the average size of data stored in the first memory area MEM_AREA_1) to the total storage capacity of the first memory area MEM_AREA_1) determined based on the past data storage history of the first memory area MEM_AREA_1 (e.g., the average capacity of data stored in the first memory area MEM_AREA_1 over a predetermined time period).

When the ratio R is equal to or greater than the threshold ratio (S520-Y), the controller 120 may determine that the deletion condition is met (S530). In this case, if the controller 120 determines that the size of the data stored in the first memory area MEM_AREA_1 is large relative to the total storage capacity, it may perform an operation to delete all or part of the data stored in the first memory area MEM_AREA_1 in order to secure available storage capacity in the first memory area MEM_AREA_1.

On the other hand, when the ratio R is less than the threshold ratio (S520-N), the controller 120 may determine that the deletion condition is not met (S540). In this case, the controller 120 may determine that sufficient available storage capacity remains in the first memory area MEM_AREA_1 and may defer the operation of deleting all or part of the data stored therein.

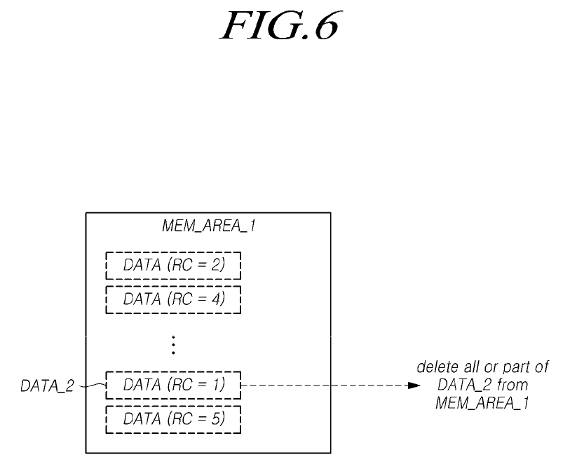

FIG. 6 illustrates an example of an operation in which the storage device 100 according to the present disclosure determines second data DATA_2 to be deleted from a first memory area MEM_AREA_1.

Referring to FIG. 6, when the aforementioned deletion condition is met, the controller 120 of the storage device 100 may delete second data DATA_2 among the data stored in the first memory area MEM_AREA_1.

In this case, the second data DATA_2 may be all or part of the data with the lowest read count among the data stored in the first memory area MEM_AREA_1. Since data with a lower read count is generally of lower importance, it may be determined that the automatic deletion of such data has minimal impact on the user.

In this case, the data stored in the first memory area MEM_AREA_1 may be a collection of data units having a preset unit size (e.g., 4KB, 16KB). The second data DATA_2 may be one or more of these data units.

The controller 120 may manage the read count of data stored in the first memory area MEM_AREA_1. To achieve this, the controller 120 may check whether a read operation has occurred for a preset memory unit (e.g., a memory block or a super memory block that includes multiple memory blocks) during a predetermined time period.

The controller 120 may internally store a table that records the read count of data stored in the first memory area MEM_AREA_1 and update the table when a read operation is performed on the data stored in the first memory area MEM_AREA_1.

In FIG. 6, the read counts (RC) of the data stored in the first memory area MEM_AREA_1 are 2, 4, ..., 1, and 5, respectively. Among them, the controller 120 may select the data with the lowest read count of 1 as the second data DATA_2 and delete all or part of the second data DATA_2 from the first memory area MEM_AREA_1.

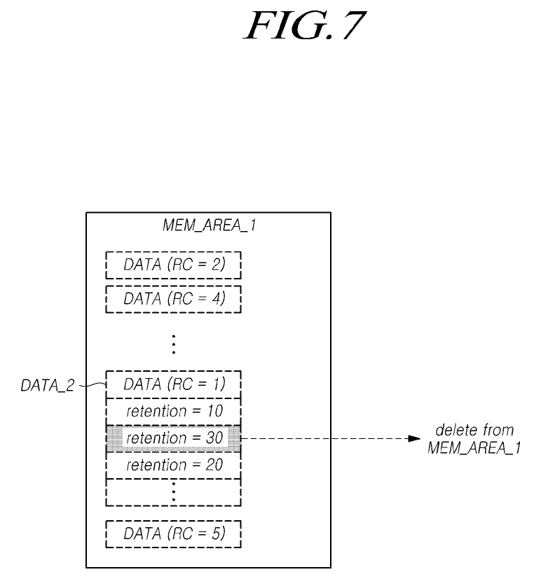

FIG. 7 is a diagram illustrating another example of an operation in which the storage device 100 according to the present disclosure determines second data DATA_2 to be deleted from the first memory area MEM_AREA_1.

Similar to FIG. 6, when the aforementioned deletion condition is met, controller 120 may delete all or part of second data DATA_2 among the data stored in the first memory area MEM_AREA_1. In this case, the second data DATA_2 may be all or part of the data with the lowest read count among the data stored in the first memory area MEM_AREA_1.

In this case, the controller 120 may determine, from among the second data DATA_2, the portion with the longest retention time that remains stored in the first memory area MEM_AREA_1, among the data with the lowest read count. The retention time of data may be an amount of elapsed time since that data was written in the storage device 100. The older the stored data having a given read count is, the less likely it is to be accessed by the user in the future.

The controller 120 may keep track of not only the read count of the data stored in the first memory area MEM_AREA_1 but also the retention time of the data stored in the first memory area MEM_AREA_1. For example, the controller 120 may record the retention time of the data stored in the first memory area MEM_AREA_1 in the same table where the read count of the data stored in the first memory area MEM_AREA_1 is recorded.

In FIG. 7, the retention times of different portions of the second data DATA_2 are 10, 30, 20, ... respectively. Among them, the controller 120 may delete the portion with the longest retention time of 30 from the first memory area MEM_AREA_1.

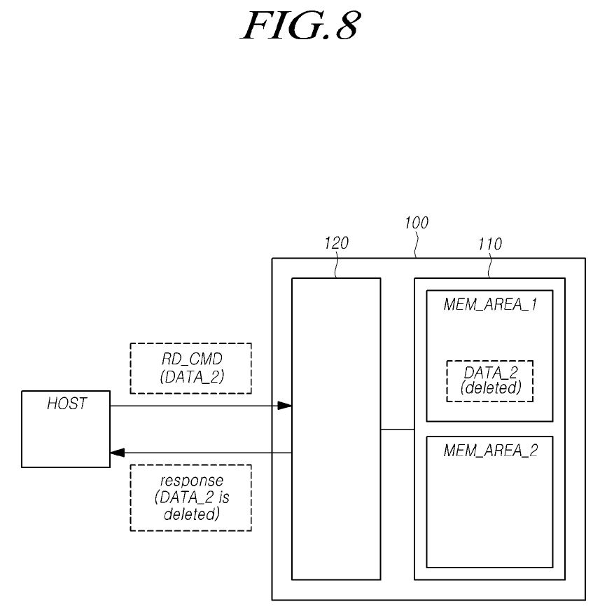

FIG. 8 is a diagram illustrating an operation in which the storage device 100 according to the present disclosure responds to a read command RD_CMD for second data DATA_2 that has been deleted from the first memory area MEM_AREA_1.

Referring to FIG. 8, the controller 120 of the storage device 100 may receive a read command RD_CMD requesting to read the second data DATA_2 and confirm that the second data DATA_2 has been deleted from the first memory area MEM_AREA_1. As described above, since the controller 120 may separately manage information regarding data automatically deleted in the first memory area MEM_AREA_1, it can also confirm that the second data DATA_2 has been deleted in the first memory area MEM_AREA_1.

Accordingly, the controller 120 may respond to the host HOST indicating that the second data DATA_2 has been deleted. Through this response, the host HOST can confirm that the second data DATA_2 has been automatically deleted from the storage device 100 and that the second data DATA_2 is no longer stored in the storage device 100.

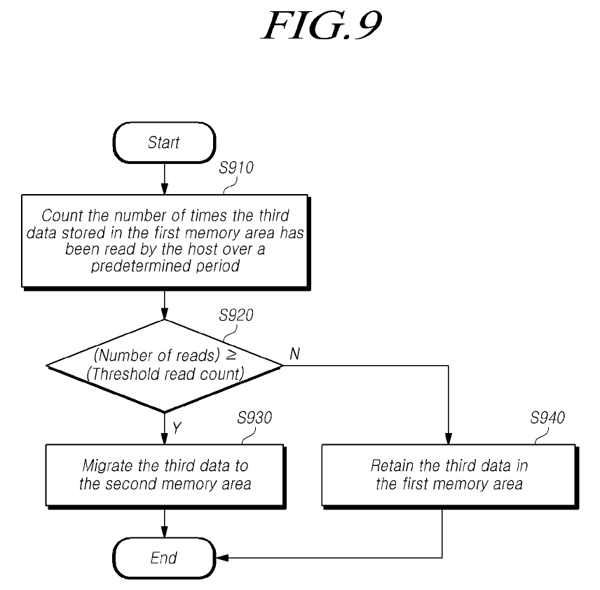

FIG. 9 is a flowchart illustrating an example of an operation in which the storage device 100 according to an embodiment of the present disclosure migrates third data DATA_3 stored in the first memory area MEM_AREA_1 to the second memory area MEM_AREA_2.

Referring to FIG. 9, the controller 120 of the storage device 100 may count the number of times that the third data DATA_3 stored in the first memory area MEM_AREA_1 has been read by the host HOST over a predetermined period of time (S910).

The controller 120 may determine whether the count produced in operation S910 is equal to or greater than a threshold read count (S920). In this case, the threshold read count may be a preset value or a value received from the host HOST.

When the number of times the third data DATA_3 has been read by the host HOST is equal to or greater than the threshold read count (S920-Y), the controller 120 may migrate the third data DATA_3 from the first memory area MEM_AREA_1 to the second memory area MEM_AREA_2 (S930). As a result, the third data DATA_3 is no longer subject to automatic deletion by the storage device 100.

If data has been read by the host HOST at least as many times as the threshold read count over a predetermined period, it is likely that the data is important to the user. Accordingly, in order to minimize the impact of automatic deletion, the controller 120 may migrate the data to the second memory area MEM_AREA_2 so that it is not automatically deleted.

On the other hand, when the number of times the third data DATA_3 has been read by the host HOST is less than the threshold read count (S920-N), the controller 120 may retain the third data DATA_3 in the first memory area MEM_AREA_1 (S940).

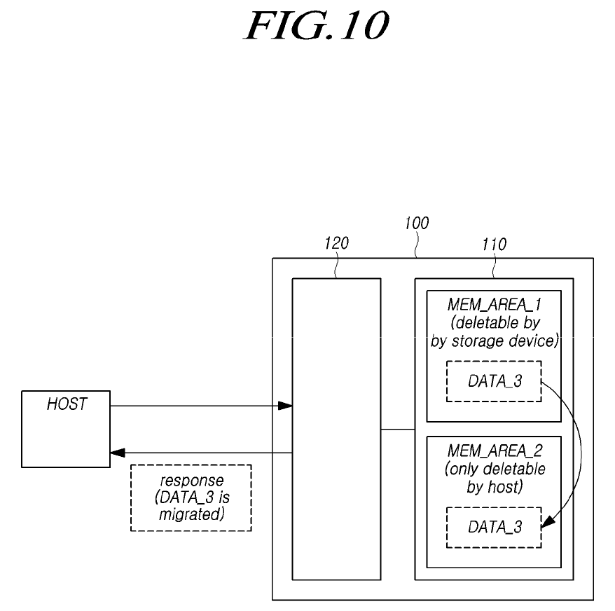

FIG. 10 is a diagram illustrating an operation in which the storage device 100 according to the present disclosure responds to the host HOST indicating that the third data DATA_3 has been migrated to the second memory area MEM_AREA_2.

Referring to FIG. 10, after the third data DATA_3 has been migrated from the first memory area MEM_AREA_1 to the second memory area MEM_AREA_2, the controller 120 of the storage device 100 may respond to the host HOST indicating that the third data DATA_3 has been migrated to the second memory area MEM_AREA_2.

For example, when the controller 120 receives a read command for the third data DATA_3 from the host HOST, it may generate a response indicating that the third data DATA_3 has been migrated to the second memory area MEM_AREA_2 and transmit the response to the host HOST.

In another example, the controller 120 may generate a response directly indicating that the third data DATA_3 has been migrated to the second memory area MEM_AREA_2 without waiting for a command from the host HOST and transmit the response to the host HOST.

Through the above-described response, the host HOST can confirm that the third data DATA_3 has been migrated to the second memory area MEM_AREA_2 and, accordingly, is no longer subject to automatic deletion by the storage device 100.

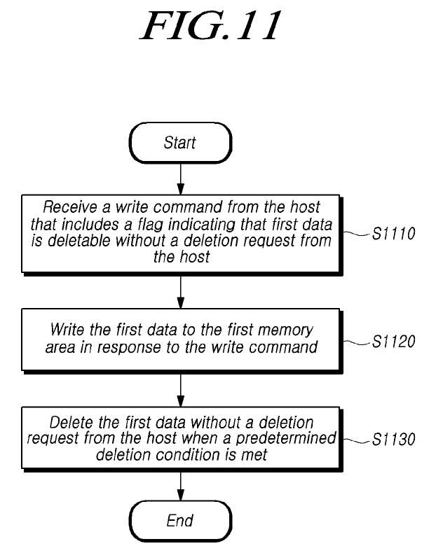

FIG. 11 is a diagram illustrating a process (method) of operating the storage device 100 according to the present disclosure.

Referring to FIG. 11, the process of operating the storage device 100 may comprise a operation (S1110) of receiving, from a host HOST, a write command WR_CMD requesting to write first data DATA_1. In this case, the write command WR_CMD may include a flag FLG indicating that the first data DATA_1 may be deleted without a deletion request from the host HOST.

The process of operating the storage device 100 may further include a operation (S1120) of writing the first data DATA_1 to the first memory area MEM_AREA_1 in response to the write command WR_CMD.

The process of operating the storage device 100 may further include a operation (S1130) of deleting first data DATA_1 without a deletion request from the host HOST when a predetermined deletion condition is met.

In one example, in operation S1130, the deletion condition may be considered met when the ratio of the size of data stored in the first memory area MEM_AREA_1 to the total storage capacity of the first memory area MEM_AREA_1 is equal to or greater than a threshold ratio.

In another example, in operation S1130, the controller 120 may delete the second data DATA_2, which is all or part of the data with the lowest read count among data stored in the first memory area MEM_AREA_1. The second data DATA_2 may be the portion of the data with the longest retention time that has remained stored in the first memory area MEM_AREA_1, among the data with the lowest read count.

In this case, the process of operating the storage device 100 may further include the operations of receiving, from the host HOST, a read command RD_CMD requesting to read second data DATA_2 and responding to the host HOST indicating that the second data DATA_2 has been deleted.

Additionally, the process of operating the storage device 100 may further include a operation of migrating the third data DATA_3 to the second memory area MEM_AREA_2 when the number of times the third data DATA_3 stored in the first memory area MEM_AREA_1 has been read by the host HOST over a predetermined period is equal to or greater than a threshold read count.

In this case, the process of operating the storage device 100 may further include a operation of transmitting a notification to the host HOST indicating that the third data DATA_3 has been migrated to the second memory area MEM_AREA_2.

Although illustrative embodiments of the present disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the present disclosure is not limited by the embodiments and the accompanying drawings. The scope of the disclosure should be interpreted in connection with the appended claims and encompass all equivalents falling within the scope of the appended claims.

What is claimed is:

1. A storage device comprising:
a memory including a first memory area; and
a controller configured to:
receive, from a host, a write command requesting to write first data,
write the first data to the first memory area in response to the write command, and
when a predetermined deletion condition is met, delete all or part of the data stored in the first memory area without a deletion request from the host.

2. The storage device according to claim 1, wherein the write command includes a flag indicating that the first data is deletable without a deletion request from the host.

3. The storage device according to claim 1, wherein the controller determines that the deletion condition is met when the ratio of the size of data stored in the first memory area to the total storage capacity of the first memory area is equal to or greater than a threshold ratio.

4. The storage device according to claim 1, wherein the controller deletes second data that is all or part of the data with a lowest read count among the data stored in the first memory area without a deletion request from the host.

5. The storage device according to claim 4, wherein the controller determines a portion of the data with a longest retention time among the data with the lowest read count as the second data.

6. The storage device according to claim 4, wherein, when receiving a read command requesting to read the second data from the host, the controller responds to the host indicating that the second data has been deleted.

7. The storage device according to claim 1,
wherein the memory further comprises a second memory area, and
wherein the controller migrates third data stored in the first memory area to the second memory area when a number of times the third data has been read by the host over a predetermined period is equal to or greater than a threshold read count.

8. The storage device according to claim 7, wherein the controller transmits an indication to the host indicating that the third data has been migrated to the second memory area.

9. A method of operating a storage device comprising a first memory area, the method comprising:
receiving, from a host, a write command requesting to write first data;
writing the first data to the first memory area in response to the write command; and
deleting the first data from the storage device without a deletion request from the host when a predetermined deletion condition is met.

10. The method of claim 9, wherein the write command comprises a flag indicating that the first data is deletable without a deletion request from the host.

11. The method of claim 9, wherein deleting the first data comprises determining that the deletion condition is met when the ratio of a size of data stored in the first memory area to the total storage capacity of the first memory area is equal to or greater than a threshold ratio.

12. The method of claim 9, wherein deleting the first data comprises deleting second data, the second data being all or part of the data with a lowest read count among the data stored in the first memory area.

13. The method of claim 12, wherein the second data is the portion of the data with a longest retention time among the data with the lowest read count.

14. The method of operating a storage device according to claim 12, further comprising:
receiving, from the host, a read command requesting to read the second data; and
responding to the read command by transmitting to the host an indication that the second data has been deleted.

15. The method of operating a storage device according to claim 9, further comprising migrating third data stored in the first memory area to a second memory area included in the storage device when a number of times the third data has been read by the host over a predetermined period is equal to or greater than a threshold read count.

16. The method of operating a storage device according to claim 15, further comprising: transmitting to the host an indication that the third data has been migrated to the second memory area.
